(19) United States
(12) Patent Application Publication
(10) Pub. No.: US 2012/0297412 A1
(43) Pub. Date: Nov. 22, 2012

(54) Video-On-Demand (VOD) Catalog Search via Image Recognition

(76) Inventors: Charles Dasher, Lawrenceville, GA (US); Anthony Richard Jones, Farnham (GB); Chris Phillips, Hartwell, GA (US)

(21) Appl. No.: 13/108,150

(22) Filed: May 16, 2011

(51) Int. Cl. H04N 7/16; H04N 7/173; H04N 7/025; G06K 9/00

(52) U.S. Cl. 725/25; 382/100; 725/93; 725/34

(57) ABSTRACT

A Video On Demand (VOD) system having a VOD catalog that lists VOD movies available for a user to purchase, a database for storing a plurality of reference images associated with the VOD movies in the VOD catalog, and an image processing and lookup system (IPLS) for searching the plurality of reference images in the database utilizing automated image recognition. A user takes a photograph of a movie poster or DVD box cover and sends the image to the IPLS. The IPLS determines whether the user image matches a stored reference image. If so, the IPLS sends an indication to the user that the movie associated with the matching image is available in the VOD catalog. When the received image does not match any image in the database, the IPLS sends an indication to the user that there are no movies in the VOD catalog matching the user image.

### BACKGROUND

The present invention relates to television delivery systems. More particularly, and not by way of limitation, the present invention is directed to a system and method for searching a Video On Demand (VOD) catalog utilizing image recognition, for example by recognizing an image on a poster or box cover.

VOD systems allow users to purchase and consume multimedia content within their own Multiple System Operator (MSO)/cable system. The user accesses a catalog of available VOD content and selects a movie or other content for viewing. The selected content is played out through a Set Top Box (STB) and television (TV) within the user's premises.

In order to search for a movie title within a VOD catalog, the user currently has to enter information into a search form. Alternatively, some systems now enable the user to scan a barcode or other glyph that can be interpreted by a software system to retrieve embedded information such as Universal Product Code (UPC) information about the title.

Using barcodes, however, is limiting in that the manufacturer must include a barcode on the packaging in order for the title information or UPC code to be retrieved. Movie advertisements such as posters generally do not include this sort of information. When they do, the information is related to the UPC code for the poster, not for the movie it advertises.

### SUMMARY

The present invention enables a user utilizing a digital camera to search a VOD catalog by taking a photograph of an image such as a movie advertisement poster, a cover of a book, a cover of a DVD case, and the like. Using a heuristic system, the invention interprets the image and determines a movie title related to the image. The determined title may optionally be presented to the user for confirmation before searching the VOD catalog to determine whether the determined title is available.

In one embodiment, the present invention is directed to a method in a VOD system for searching a catalog of VOD content utilizing automated image recognition. The method includes the steps of receiving at an image processing and lookup system, an image from a user's imaging device; comparing by the image processing and lookup system, the received image with a plurality of stored reference images associated with VOD content in the VOD catalog; and determining whether the received image matches a stored reference image associated with a piece of VOD content in the VOD catalog. When the received image matches an image associated with a piece of VOD content in the VOD catalog, the image processing and lookup system sends to the user, an indication that the matching piece of VOD content is available in the VOD catalog. When the received image does not match an image associated with a piece of VOD content in the VOD catalog, the image processing and lookup system sends to the user, an indication that the matching piece of VOD content is not available in the VOD catalog.

In another embodiment, the present invention is directed to an image processing and lookup system (IPLS) for searching a catalog of VOD content utilizing automated image recognition. The IPLS includes a communication interface configured to receive an image from a user's imaging device; and an image recognition processor configured to compare the received user image with a plurality of stored reference images associated with VOD content in the VOD catalog to determine whether the received user image matches a stored reference image associated with a piece of VOD content in the VOD catalog. When the received image matches an image associated with a piece of VOD content in the VOD catalog, a control processor causes the communication interface to send from the IPLS to the user, an indication that the matching piece of VOD content is available in the VOD catalog. When the received image does not match an image associated with a piece of VOD content in the VOD catalog, the control processor causes the communication interface to send from the IPLS to the user, an indication that the matching piece of VOD content is not available in the VOD catalog.

In another embodiment, the invention is directed to a VOD system that includes a VOD catalog that lists VOD content available for a user to purchase; a database for storing a plurality of reference images associated with the VOD content in the VOD catalog; and an image processing and lookup system (IPLS) for searching the plurality of reference images in the database utilizing automated image recognition. The IPLS includes a communication interface configured to receive an image from a user's imaging device, and an image recognition processor configured to compare the received user image with a plurality of stored reference images associated with VOD content in the VOD catalog to determine whether the received user image matches a stored reference image associated with a piece of VOD content in the VOD catalog. When the received image matches an image associated with a piece of VOD content in the VOD catalog, a control processor causes the communication interface to send from the IPLS to the user, an indication that the matching piece of VOD content is available in the VOD catalog. When the received image does not match an image associated with a piece of VOD content in the VOD catalog, the control processor causes the communication interface to send from the IPLS to the user, an indication that the matching piece of VOD content is not available in the VOD catalog.

Using this system, users can quickly find title information and determine availability through their VOD system without the need for a barcode or other glyph. For example, a user may simply point a camera at movie poster and schedule an alert notification for when the advertised movie is available in the VOD catalog.

### BRIEF DESCRIPTION OF THE DRAWINGS

In the following section, the invention will be described with reference to exemplary embodiments illustrated in the figures, in which:

FIG. 1 is a simplified block diagram of an exemplary embodiment of a VOD system in which the present invention has been implemented;

FIG. 2 is a simplified block diagram of an Image Processing and Lookup System (IPLS) in an exemplary embodiment of the present invention; and

FIG. 3 is a flow chart illustrating the steps of an exemplary embodiment of the method of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that the invention may be implemented in hardware or in a combination of hardware and software. For example, one or more computers or processors may perform the steps of the method of the present invention when executing computer program instructions stored in one or more non-transitory program memories.

In one embodiment of the present invention, an unknown image of a movie poster or DVD cover is compared to a plurality of known reference movie posters/DVD box cover images. Heuristics are used to index the reference images. The algorithms for determining a match are described below. The indexing information is stored in a database for reference images. When a comparison to an unknown image is requested, a reference image is uploaded to a server component, which generates comparison data on the uploaded reference image. The server component analyzes the unknown image by comparing certain traits against a known set of images that relate to movie titles. Upon a successful comparison, all metadata relating to the movie title are conveyed back to the user to be used.

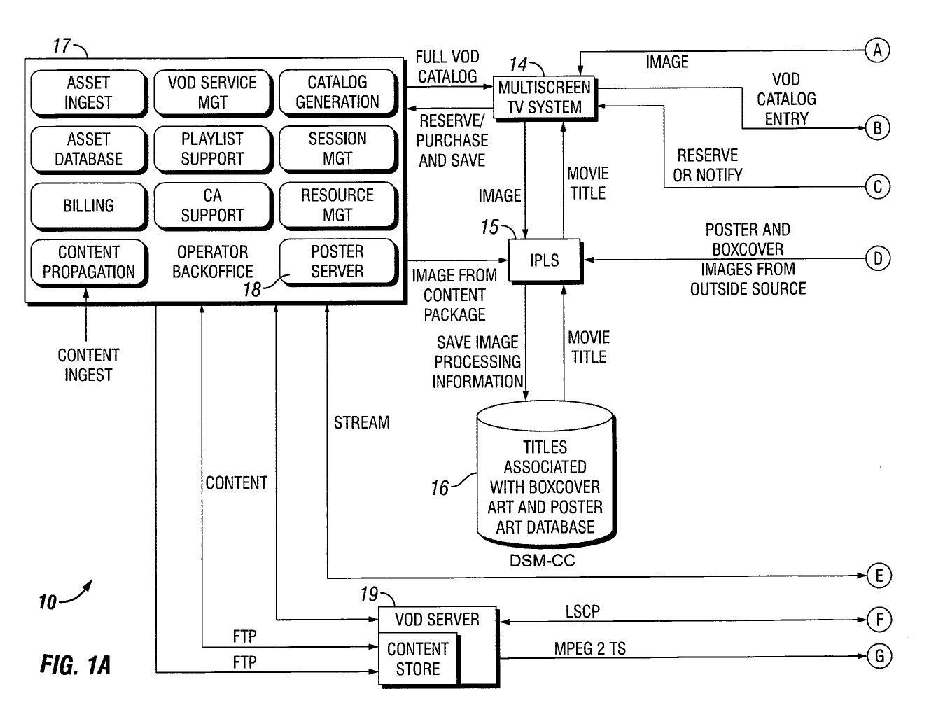

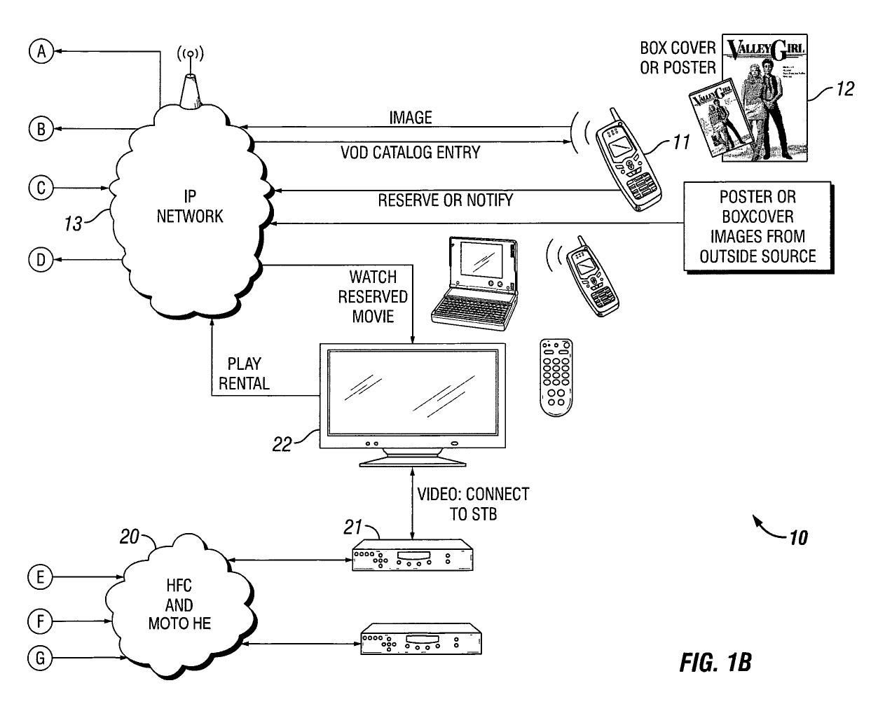

FIG. 1 is a simplified block diagram of an exemplary embodiment of a VOD system 10 in which the present invention has been implemented. The system includes a user's digital imaging device 11 such as a digital camera, cell phone with a camera, smartphone with a camera, or other digital imaging device. After taking an image of a movie poster or DVD box cover 12, the camera or phone uploads the digital image through an Internet Protocol (IP) network 13 to a multi-screen TV system 14. The multi-screen TV system interfaces with an Image Processing and Lookup System (IPLS) 15, and forwards the poster or box cover image to the IPLS. The IPLS has access to a database 16 of movie titles and associated poster and/or box cover images, which it compares to the digital image received from the user.

The VOD system 10 also includes an Operator Back Office 17, which performs conventional management functions, and also includes a Poster Server 18 that populates the database 16 with poster and box cover images and associated movie information from VOD content available in the VOD catalog. For completeness, FIG. 1 also shows components enabling the user to purchase and view VOD content from the VOD system such as a VOD Server and Content Store 19, a Hybrid Fiber-Coaxial (HFC) access network and Headend (HE) 20, a Set Top Box (STB) 21, and a television (TV) 22.

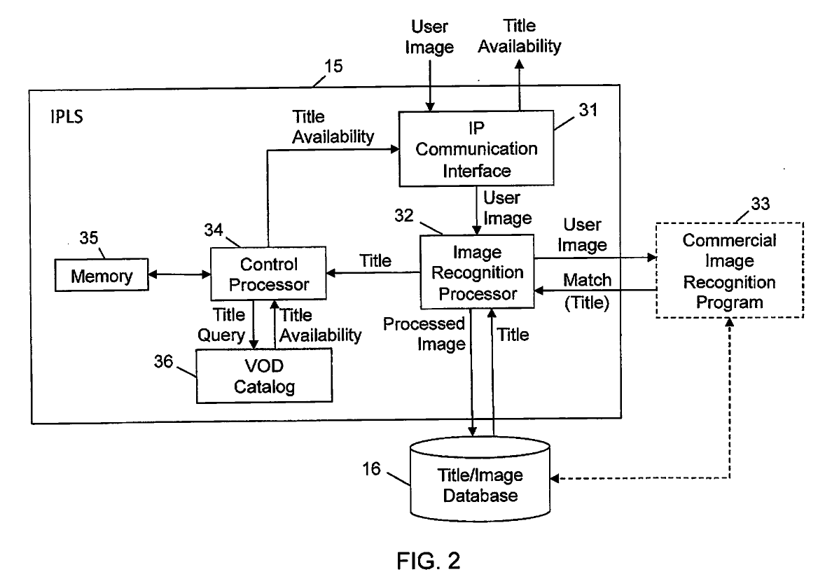

FIG. 2 is a simplified block diagram of the IPLS 15 in an exemplary embodiment of the present invention. The users' poster or box cover image is received through an IP communication interface 31, which passes the image to an image recognition processor 32. In one embodiment, the image recognition processor interfaces with a commercially available image recognition program 33 to compare attributes of the user's poster or box cover image to attributes of images stored either in the database 16 or in a remote database (not shown). The commercially available image recognition program may be executed by the image recognition processor 32, or may be executed remotely as a “cloud service”. Suitable commercially available image recognition programs include, for example, the Kooaba application programming interface (API) available from the Kooaba Company (www.kooaba.com) or the TinEye, Piximilar, or PixMatch APIs from Wee, Inc. (www.ideeinc.com). The Kooaba API, for example, may reside remotely (i.e., a cloud service) with the IPLS accessing it through Representational State Transfer (REST), a Hypertext Transfer Protocol (HTTP) style of software architecture. An available “Query API” may be utilized to make requests to Kooaba's existing database of millions of images. A “Data API” may be utilized to upload a user's own data for recognition.

When a match is found between the user's poster or box cover image and an image stored in the database, the commercially available image recognition program 33 returns a matching title, which is forwarded to a control processor 34. The control processor may control the operation of the IPLS by executing computer program instructions stored on a non-transitory memory device 35. When the control processor receives the matching title, and the commercially available image recognition program used its own database of reference images, the control processor queries the VOD catalog 36 to determine whether the title is currently available in the VOD catalog. The VOD catalog returns an indication of the title availability, which the control processor forwards to the IP communication interface 31. When the control processor receives the matching title, and the commercially available image recognition program used the title/image database 16 (which is populated with titles and images from the VOD catalog), the control processor does not have to query the VOD catalog. Instead, the control processor can immediately forward an indication of the title availability to the IP communication interface. The IPLS 15 then sends an indication to the user via the multi-screen TV system 14 and the IP network 13 (FIG. 1) indicating that the associated movie is available in the VOD catalog. The IPLS may also send information about the associated movie title to the user.

In another embodiment, the IPLS 15 performs a three-tiered approach for image recognition as described below. This functionality may reside, for example, in the image recognition processor 32. It should be noted that the first algorithm described below will work for color images; however, for black and white images the first algorithm will not be reliable.

By way of background, if an array of pixels (for example 512×512) is analyzed, and each pixel provides a sample of luminance, the array can be represented as an array of 512×512 values, where each sample is transformed representing a two-dimensional spatial component. This was classically done using Discrete Cosine Transform (DCT) for MPEG-2, and then an integer transform for H.264. Other methodologies are also possible. If the values are arranged as a grid with the top left corner representing the lowest spatial frequency, values to the right represent higher horizontal spatial frequencies. An index value (u) may be utilized in the horizontal dimension. Likewise in the vertical direction, an increasing value of an index (v) represents increasing vertical spatial frequency. The (0,0) location is a special case and is a DC value (i.e., it is merely the mean of all the samples). Moving to row 1 or column 1 represents the fundamental frequency of the sample array; row 2 or column 2 is the 2nd harmonic, and so on.

The lower harmonics are more useful from a recognition point of view than the higher ones, so a subset of the lower harmonics may be defined, with the value ‘G’ being the upper limit of spatial frequencies of interest. It should be noted that spatial frequencies are independent of resolution; i.e., if a spatial transform is done of the same picture with 1024×1024 pixels sampled, then the (1,1) spatial frequency component will be exactly equivalent to the (1,1) spatial frequency component of the 512×512 version, and so on. The only difference would be that there are more transformed values in the grid=higher maximum spatial frequency. There are no entries above row or column 512-1, because this has no representation in the original data. Hence u,v are limited to range 0 . . . 512-1.

The three-tiered approach for image recognition is as follows:

1) Example Index Matching Criteria for Image Comparison

If the image is Red, Green, Blue (R,G,B) sampled, then transform from RGB to YPrPb using the transform:

Y=0.299R+0.587G+0.114B

Pr=R−Y

Pb=B−Y

where Y is the luminance and Pr and Pb are chrominance (color difference) values.

Hue θ is the angle defined by tan⁻¹ (Pr/Pb). The calculation needs to make sure that the correct quadrant is returned and that |Pb| and |Pr| are compared to select whether to calculate θ or (π/2−θ) to avoid numeric overflows.

Saturation=(Pb²+Pr²)^{1/2}

2) Transform Coefficient Ratios

If the sampled image is in a rectangle of dimensions N by M, then the DCT transform is defined below:

$$F ( u , v ) = {( \frac{2}{N} )}^{\frac{1}{2}} {( \frac{2}{M} )}^{\frac{1}{2}} {\sum }_{i = 0}^{N - 1} {\sum }_{j = 0}^{M - 1} Λ ( i ) \cdot Λ ( j ) \cdot cos [ \frac{π \cdot u}{2 \cdot N} ( 2 i + 1 ) ] cos [ \frac{π \cdot v}{2 \cdot M} ( 2 j + 1 ) ] \cdot f ( i , j )$$

$$where$$

$$Λ ( i ) = \{ \begin{matrix}\frac{1}{\sqrt{2}} & for ξ = 0 \\ 1 & otherwise\end{matrix}$$

f(i,j) is the luminance sample Y (which should be a value between 0 and 255 inclusive);

(u,v) are spatial frequency points in the horizontal and vertical dimensions; and

(i,j) are index values utilized to select the pixels that are within the sample rectangle.

Apply this transform to the spatial frequency points (u,v) in the horizontal and vertical dimensions (for example u,v=0 to G−1 inclusive) where G provides a limit for values of u and v, and G−1 is the maximum spatial frequency evaluated in each dimension.

F(1,1) represents a measure of the fundamental spatial frequency in both dimensions and provides a useful reference point for other spatial frequencies.

To provide a signature of the image, select a subset of F(u,v) for u.v=0 to G−1 inclusive, and evaluate the following:

if F(1,1)< >0
W(u,v)=F{u,v)/F(1,1)

else
W(u,v)=not valid

For a pre-determined value G, typically in the range 3 to 6, the following is stored in the database for the asset as a reference:

a) W(u,v) (either in fractional binary format—e.g., with 8 fractional bits), or log(W(u,v))

b) F(u,v)

|F(u,v)| provides a measure of the confidence achieved with a match with W(u,v).

3) Hue Angle Calculation

Define four rectangles A, B, C, and D such that:

A is the region between i,j=(N/8 and 3N/8−1)

B is the region between i=(5N/8 and 7N/8−1); j=(N/8 and 3N/8−1)

C is the region between i=(N/8 and 3N/8−1); j=(5N/8 and 7N/8−1)

D is the region between i,j=(5N/8 and 7N/8−1)

θ_{A}, θ_{B}, θ_{C}, θ_{D}, are the hue angles evaluated for the mean chrominance values for regions A, B, C, D, respectively.

S_{A}, S_{B}, S_{C}, S_{D} are the saturations for regions A, B, C, D, respectively. The saturation values provide a confidence measure for the associated hue angles. In addition, the ratios (S_{A}/S_{D}) and (S_{B}/S_{D}) provide additional metrics, with confidence values that are defined by |S_{A}−S_{D}| and |S_{B}−S_{C}| respectively. Either (S_{A}/S_{D}) or log(S_{A}/S_{D}) may be used.

Thus, the process results in six values based on chrominance, plus a number of values based on transformed luminance coefficient ratios. For each, the value plus a confidence measure are stored.

### Image Index Comparison Between Referenced (Databased Calculations) and Incoming (Uploaded Image Calculations)

When comparing images, exact matches to metrics are unlikely due to differences between lighting, gamma, and so forth, so an index match should use a number of the metrics, with strength and weighting values.

A strength value λₚ for metric p may be formed by evaluating:

λₚ=|Cₚ|/(Kₚ|(Rₚ−Cₚ|), limited to a defined maximum value,

where:
Cₚ is the candidate image metric strength value for metric p;
Rₚ is the reference image metric strength value for metric p;
Kₚ is a weighting factor for metric p determined empirically; and
p is an index used to select which of the metrics are being used.

Similarly, μₚ for metric p may be obtained by evaluating:

μₚ=|Mₚ|/(Lₚ+|(Mₚ−Xₚ|),

where:
Mₚ is the value for the candidate for metric p;
Xₚ is the value for the reference image for metric p; and
Lₚ is a weighting factor for metric p determined empirically.

A match score for metric p is then calculated as:

φₚ=μₚ*λₚ.

Finally, the overall match value can be calculated as follows:

match=Σψₚ for all metrics p.

Thus, the match is simply a sum of the metrics that are available, i.e., one or more of the hue matching, transform coefficient ratio matching, saturation ratio matching, and the like. Different implementations may choose which to use, as each provides some information, however no one metric is good for all circumstances. Therefore a combination of metrics that assess the match for different attributes is valuable.

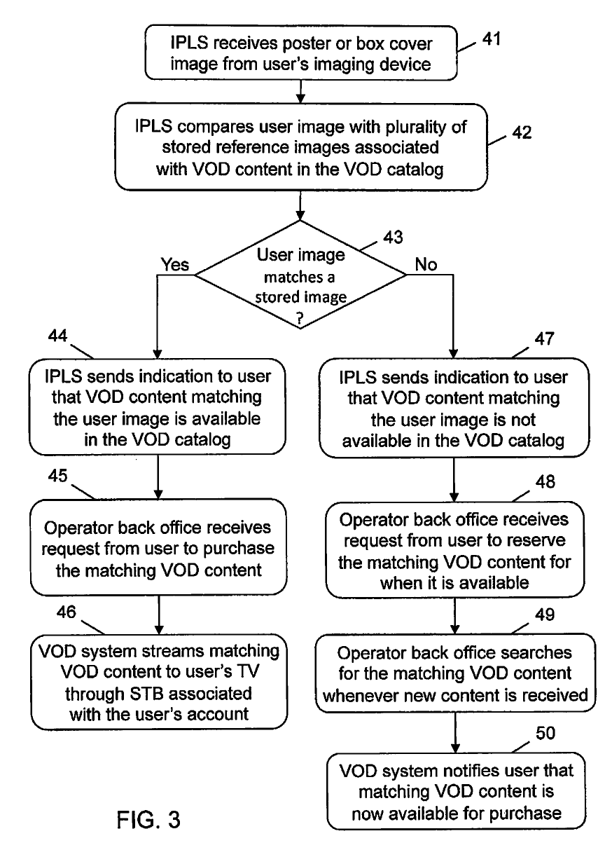

FIG. 3 is a flow chart illustrating the steps of an exemplary embodiment of the method of the present invention for searching a catalog of VOD content utilizing automated image recognition. At step 41, the IPLS 15 receives a poster or box cover image from a user's imaging device. At step 42, the IPLS compares the received user image with a plurality of stored reference images associated with VOD content in the VOD catalog. At step 43, it is determined whether the received user image matches a stored reference image associated with a piece of VOD content in the VOD catalog. If so, the method moves to step 44 where the IPLS sends an indication to the user that the matching piece of VOD content is available in the VOD catalog. Thereafter, at step 45, the operator back office 17 receives a request from the user to purchase the matching VOD content. At step 46, the VOD system streams the matching VOD content to the user television 22 through the user's STB 21 associated with an account of the user.

However, if it is determined at step 43 that the received user image does not match a stored reference image associated with a piece of VOD content in the VOD catalog, the method moves from step 43 to step 47 where the IPLS 15 sends an indication to the user that the matching piece of VOD content is not available in the VOD catalog. At step 48, the operator back office 17 receives a request from the user to reserve the VOD movie when it becomes available. At step 49, the operator back office searches for the matching VOD content whenever new VOD content is received. At step 50, upon determining that the matching VOD content has been received, the VOD system notifies the user that the matching VOD content is currently available for purchase.

Use Case for VOD Package Ingest from Operator's Back Office

1) A VOD package (movie) is pushed into the Operator's back office.

2) The VOD package contains poster and/or box cover art.

3) The back office pushes the poster art into the Poster/Box cover Image Processing and Lookup System.

4) The algorithm described above is applied to the reference image.

5) The reference metrics calculated from (4) are stored with this movie.

Use Case for Storing an Image with Title Ingest (for Reservation, No Back Office Catalog Entry)

1) An external (either on the Operator's network or the Internet) system is configured on the Poster/Box cover Image Processing and Lookup System.

2) The Poster/Box cover Image Processing and Lookup System may either pull the image/title information from the external system or services may be set up based on APIs to allow the external systems to push the image/title information into the Poster/Box cover Image Processing and Lookup System.

3) The algorithm described above is applied to the reference image.

4) The reference metrics calculated from (3) are stored with this movie title in the data store.

Image Lookup with VOD Back Office Match (Title Currently in VOD Catalog)

1) A user is running an operator's back office application on a smart device with a camera.

2) The user is in a DVD movie retail location and selects a Blue-ray disc which the user is debating to purchase. Since the user has not seen the movie, the user remembers the VOD lookup by image feature.

3) The user runs the application and selects Art Image Lookup.

4) The user's smart device switches to camera mode, and the user takes a photograph of the image on the DVD box.

5) The user's smart device pushes the image via WIFI or mobile wireless into the operator's network and into the Poster/Box cover Image Lookup System for lookup.

6) The image processing algorithms are applied to the lookup image using the algorithms described above.

7) The three-step process is followed for lookup matches.

8) If the system finds a match or a limited number of matches, they are displayed on the user's smart device as possible choices.

9) The user selects the title for reservation/rental.

10) The user is prompted to watch now or watch later.

11) If watch now is selected, the title plays on the user's smart device.

12) If watch later is selected, the title is placed the reserved rentals category for ease of watching later on any device the operator supports (Set top box play, mobile device play, or web device play).

Image Lookup with VOD Back Office Match (Title not Currently in VOD Catalog)

1) A user is running an Operator's back office application on a smart device with a camera.

2) The user is in a movie theater and watches a movie.

3) After the movie is completed, the user is leaving the theater.

4) The user loved the movie and would like to watch it again as soon as it is released to be viewed in the home.

5) The user remembers the application running on the user's smart device and remembers the Poster/Box cover art lookup feature.

6) The user walks up to the movie poster displayed in the lobby of the theater.

7) The user runs the operator's smart device application on the user's device and selects Art Image Lookup.

8) The user's smart device switches to camera mode, and the user takes a photograph of the poster image.

9) The smart device pushes the image via WIFI or mobile wireless into the operator's network and into the Poster/Box cover Image Lookup System for lookup.

10) The image processing algorithms are applied to the lookup image using the algorithms described above.

11) The three-step process is followed for lookup matches.

12) If the system finds a match or a limited number of matches, they are displayed as possible choices.

13) The user selects the title for reservation/rental.

14) Since the selected title is still in theaters, it is not in the VOD catalog for purchase.

15) The system notifies the user that the selected movie title is not currently available. The user is also presented with an option to be notified as soon as it is available. The user selects “Yes”.

16) Several months pass and the movie is released on VOD and is ingested into the Operator's back office.

17) The user is notified that the movie is available for purchase/rental.

18) The user remembers the movie and purchases the movie.

19) The user is prompted to watch now or watch later.

20) If watch now is selected, the movie plays on the smart device.

21) If watch later is selected, the title is placed in the reserved rentals category for ease of watching later on any device the operator supports (Set top box play, mobile device play, or web device play).

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method in a Video On Demand (VOD) system for searching a catalog of VOD content utilizing automated image recognition, the method comprising the steps of:
receiving at an image processing and lookup system, an image from a user's imaging device;
comparing by the image processing and lookup system, the received image with a plurality of stored reference images associated with VOD content in the VOD catalog;
determining whether the received image matches a stored reference image associated with a piece of VOD content in the VOD catalog;
when the received image matches an image associated with a piece of VOD content in the VOD catalog, sending from the image processing and lookup system to the user, an indication that the matching piece of VOD content is available in the VOD catalog; and
when the received image does not match an image associated with a piece of VOD content in the VOD catalog, sending from the image processing and lookup system to the user, an indication that the matching piece of VOD content is not available in the VOD catalog.

2. The method according to claim 1, wherein the image received from the user's imaging device is a digital image of a movie poster or a DVD box cover, and the matching piece of VOD content is a VOD movie available for purchase by the user.

3. The method according to claim 2, wherein the step of sending the user an indication that the matching piece of VOD content is available in the VOD catalog includes sending all metadata relating to the matching VOD movie to the user.

4. The method according to claim 2, further comprising, when the received image matches an image associated with a piece of VOD content in the VOD catalog, the steps of:
receiving in an operator back office of the VOD system, a request from the user to purchase the VOD movie; and
streaming the VOD movie to a user television through a Set Top Box (STB) associated with an account of the user.

5. The method according to claim 2, further comprising, when the received image does not match an image associated with a piece of VOD content in the VOD catalog, the steps of:
receiving in an operator back office of the VOD system, a request from the user to reserve the VOD movie when it becomes available;
searching for the VOD movie whenever new VOD content is received by the operator back office; and
upon determining that the VOD movie has been received, notifying the user that the VOD movie is currently available for purchase.

6. An image processing and lookup system (IPLS) for searching a catalog of Video On Demand (VOD) content utilizing automated image recognition, the IPLS comprising:
a communication interface configured to receive an image from a user's imaging device;
an image recognition processor configured to compare the received user image with a plurality of stored reference images associated with VOD content in the VOD catalog to determine whether the received user image matches a stored reference image associated with a piece of VOD content in the VOD catalog;
wherein, when the received image matches an image associated with a piece of VOD content in the VOD catalog, a control processor causes the communication interface to send from the IPLS to the user, an indication that the matching piece of VOD content is available in the VOD catalog; and
wherein, when the received image does not match an image associated with a piece of VOD content in the VOD catalog, the control processor causes the communication interface to send from the IPLS to the user, an indication that the matching piece of VOD content is not available in the VOD catalog.

7. The IPLS according to claim 6, wherein the image received from the user's imaging device is a digital image of a movie poster or a DVD box cover, and the matching piece of VOD content is a VOD movie available for purchase by the user.

8. The IPLS according to claim 7, wherein the control processor also causes the communication interface to send from the IPLS to the user, all metadata relating to the matching VOD movie.

9. A Video On Demand (VOD) system comprising:
a VOD catalog that lists VOD content available for a user to purchase;
a database for storing a plurality of reference images associated with the VOD content in the VOD catalog;
an image processing and lookup system (IPLS) for searching the plurality of reference images in the database utilizing automated image recognition, the IPLS comprising:
a communication interface configured to receive an image from a user's imaging device;
an image recognition processor configured to compare the received user image with a plurality of stored reference images associated with VOD content in the VOD catalog to determine whether the received user image matches a stored reference image associated with a piece of VOD content in the VOD catalog;
wherein, when the received image matches an image associated with a piece of VOD content in the VOD catalog, a control processor causes the communication interface to send from the IPLS to the user, an indication that the matching piece of VOD content is available in the VOD catalog; and
wherein, when the received image does not match an image associated with a piece of VOD content in the VOD catalog, the control processor causes the communication interface to send from the IPLS to the user, an indication that the matching piece of VOD content is not available in the VOD catalog.

10. The VOD system according to claim 9, wherein the image received from the user's imaging device is a digital image of a movie poster or a DVD box cover, and the matching piece of VOD content is a VOD movie available for purchase by the user.

11. The VOD system according to claim 10, wherein the control processor also causes the communication interface to send from the IPLS to the user, all metadata relating to the matching VOD movie.

12. The VOD system according to claim 10, further comprising:
an operator back office; and
a head end for streaming VOD movie to the user;
wherein, when the received user image matches an image associated with a VOD movie in the VOD catalog, the back office is configured to receive a request from the user to purchase the VOD movie; and
wherein the head end is configured to stream the VOD movie to a user television through a Set Top Box (STB) associated with an account of the user.

13. The VOD system according to claim 10, further comprising an operator back office;
wherein, when the received image does not match an image associated with a piece of VOD content in the VOD catalog, the back office is configured:
to receive a request from the user to reserve the VOD movie when it becomes available;
to search for the VOD movie whenever new VOD content is received by the operator back office; and
upon determining that the VOD movie has been received, to notify the user that the VOD movie is currently available for purchase.
